(19) United States
(12) Patent Application Publication
(10) Pub. No.: US 2017/0289087 A1
(43) Pub. Date: Oct. 5, 2017

(54) NOTIFICATION DELIVERY TO DEVICES WITHOUT APPROPRIATE APPLICATIONS INSTALLED

(71) Applicant: Google Inc., Mountain View, CA (US)

(72) Inventors: Austin N. Chang, San Francisco, CA (US); Balaji Srinivasan, Saratoga, CA (US); Ivan Lee, Mountain View, CA (US); Joshua Oldmeadow, Sunnyvale, CA (US); Thomas R. Karlo, San Francisco, CA (US); Francesco Nerieri, Santa Cruz, CA (US); Daniel R. Sandler, Burlington, MA (US); Somaskanda Thyagaraja, San Francisco, CA (US); Xiaoyong Liu, Clyde Hill, WA (US); Peter H. Williamson, Kirkland, WA (US)

(73) Assignee: Google Inc., Mountain View, CA (US)

(21) Appl. No.: 14/080,781

(22) Filed: Nov. 14, 2013

Related U.S. Application Data
(60) Provisional application No. 61/823,381, filed on May 14, 2013.
(60) Provisional application No. 61/802,159, filed on Mar. 15, 2013.

(51) Int. Cl. H04L 12/58

(52) U.S. Cl. CPC H04L 51/24

(57) ABSTRACT

Systems, methods and computer readable media for delivery of notifications to devices without appropriate applications installed are disclosed. In some implementations, the systems, methods and computer readable media can deliver a notification message and process a response via an alternate mode when an appropriate application is not installed.

### RELATED APPLICATIONS

This application claims the benefit of U.S. Provisional Application No. 61/802,159, filed on Mar. 15, 2013, titled “Notification Delivery to Devices Without Appropriate Applications Installed”, and of U.S. Provisional Application No. 61/823,381, filed on May 14, 2013 and titled “Notification Delivery to Devices Without Appropriate Applications Installed”, both of which are incorporated herein by reference in their entirety.

### BACKGROUND

Some computer users may rely on a plurality of devices to communicate with others and to receive notifications on. These devices can include desktop and laptop computers, as well as other wireless devices such as smart phones, tablet devices, media players, and the like. The various devices associated with a user or user account may have different capabilities and or applications installed that may not be appropriate for presenting some notifications. Some devices may not be able to process or present notifications in that same way as other devices.

### SUMMARY

Some implementations relate generally to notification delivery and more particularly to notification delivery to devices without appropriate applications installed. Some implementations can include a method. In some implementations, the method can include receiving a notification message having a recipient associated with the notification message and accessing account information associated with the recipient including a list of one or more devices associated with the account. The method can also include identifying a target device associated with the recipient and determining whether the target device has an appropriate application installed to process the notification message. The method can further include when the target device has an appropriate application installed, delivering the notification message to the appropriate application; and when the target device does not have an appropriate application installed, delivering the notification message via an alternate delivery mode, wherein the alternate delivery mode includes one of delivering a notification to an installed application directing the recipient to another device associated with the recipient, and connecting the recipient to an alternate version of the application sending the notification message.

Some implementations can include a method comprising receiving a notification message and identifying a target device associated with a recipient of the notification message. The method can also include determining whether the target device has an appropriate application installed to process the notification message and when the target device has an appropriate application installed, delivering the notification message to the appropriate application. The method can further include when the target device does not have an appropriate application installed, delivering the notification message via an alternate delivery mode.

The alternate delivery mode can include one of delivering a notification to an installed application directing the recipient to another device associated with the recipient, and connecting the recipient to an alternate version of the application sending the notification message. The alternate delivery mode can also include delivering a notification to an installed application directing the recipient to use another device associated with the recipient to receive the notification, the other device having an appropriate application installed.

The target device can include the device that the recipient is actively using. The target device can include the device that was most recently used by the recipient. The alternate delivery mode includes presenting one or more actionable user interface elements with the notification message, wherein the one or more actionable user interface elements have been modified based on the capabilities of the target device.

The method can also include delivering low-priority notifications to a low priority section of a user interface regardless of whether an appropriate application is installed for handling the low-priority notification. The alternate delivery mode can include connecting the recipient to an alternate version of the application sending the notification message, and wherein the alternate version is a web-based version of the appropriate application viewable in a web browser on the target device.

Some implementations can include a system having one or more processors configured to perform operations. The operations can include receiving a notification message and identifying a target device associated with a recipient of the notification message. The operations can also include determining whether the target device has an appropriate application installed to process the notification message. The operations can further include when the target device has an appropriate application installed, delivering the notification message to the appropriate application, and when the target device does not have an appropriate application installed, delivering the notification message via an alternate delivery mode.

The alternate delivery mode can include one or more of delivering a notification to an installed application directing the recipient to another device associated with the recipient, prompting the recipient to download an appropriate application for handling the notification, and connecting the recipient to an alternate version of the appropriate application. The alternate delivery mode can also include delivering a notification to an installed application directing the recipient to use another device associated with the recipient to receive the notification, the other device having an appropriate application installed.

The target device can include the device that the recipient is actively using. The target device can include the device that was most recently used by the recipient. The alternate delivery mode can include presenting one or more actionable user interface elements with the notification message, wherein the one or more actionable user interface elements have been modified based on the capabilities of the target device. The one or more actionable user interface elements can be modified based on target device input capabilities. The alternate delivery mode can include connecting the recipient to an alternate version of the application sending the notification message, and wherein the alternate version is a web-based version of the appropriate application viewable in a web browser on the target device.

Some implementations can include a method comprising receiving a notification message having a recipient associated with the notification message and accessing account information associated with the recipient including a list of one or more devices associated with the account. The method can also include identifying a target device associated with the recipient. The method can also include determining that the target device does not have an appropriate application installed to process the notification message. The method can further include delivering the notification message via an alternate delivery mode.

The alternate delivery mode can include one of delivering a notification to an installed application directing the recipient to another device associated with the recipient, and connecting the recipient to an alternate version of the application sending the notification message. The alternate version can include a web-based version of the appropriate application viewable in a web browser on the target device.

### BRIEF DESCRIPTION OF THE DRAWINGS

FIG. 1 shows an example system for notification delivery in accordance with some implementations.

FIG. 2 is a flow chart for an example notification platform in accordance with some implementations.

FIG. 3 is a server diagram for notification delivery in accordance with some implementations.

FIG. 4 is a flow chart showing an example method for notification delivery based on social affinity in accordance with some implementations.

FIG. 5 is a flow chart of an example method for notification delivery based on device usage characteristics in accordance with some implementations.

FIG. 6 is a diagram of an example system for presenting notifications across multiple devices in accordance with some implementations.

FIG. 7 is a flow chart of an example method for presenting notifications across multiple devices in accordance with some implementations.

FIG. 8 is a flow chart of an example method for presenting notifications across multiple devices in accordance with some implementations.

FIG. 9 is a diagram of an example system for notification delivery to devices without appropriate applications installed in accordance with some implementations.

FIG. 10 is a flow chart of an example method for notification delivery to devices without appropriate applications installed in accordance with some implementations.

FIG. 11 is a flow chart of an example method for notification delivery via an alternate mode in accordance with some implementations.

FIG. 12 is a diagram of an example notification response via an alternate mode in accordance with some implementations.

FIG. 13 shows a diagram of an example low priority notification in accordance with some implementations.

FIG. 14 shows a diagram of an example notification user interface in accordance with some implementations.

FIG. 15 shows a diagram of an example user interface for setting notification preferences in accordance with some implementations.

FIG. 16 shows a diagram of an example user interface for viewing user information from a notification in accordance with some implementations.

FIG. 17 shows a diagram of an example user interface for viewing user information for multiple users from a notification in accordance with some implementations.

### DETAILED DESCRIPTION

Systems, methods and computer readable media for delivery of notifications to devices without appropriate applications installed are disclosed. In some implementations, the systems, methods and computer readable media can deliver a notification message to a device that does not have an application installed that is appropriate for handling the notification message. An appropriate application, as used herein, may include an application for the system or other application that generated the notification (e.g., a social network application for handling a notification from that social network) or an application capable of handling the notification data and/or response (e.g., a text, voice or video chat application configured to handle the notifications and responses to a text, voice or video chat notification).

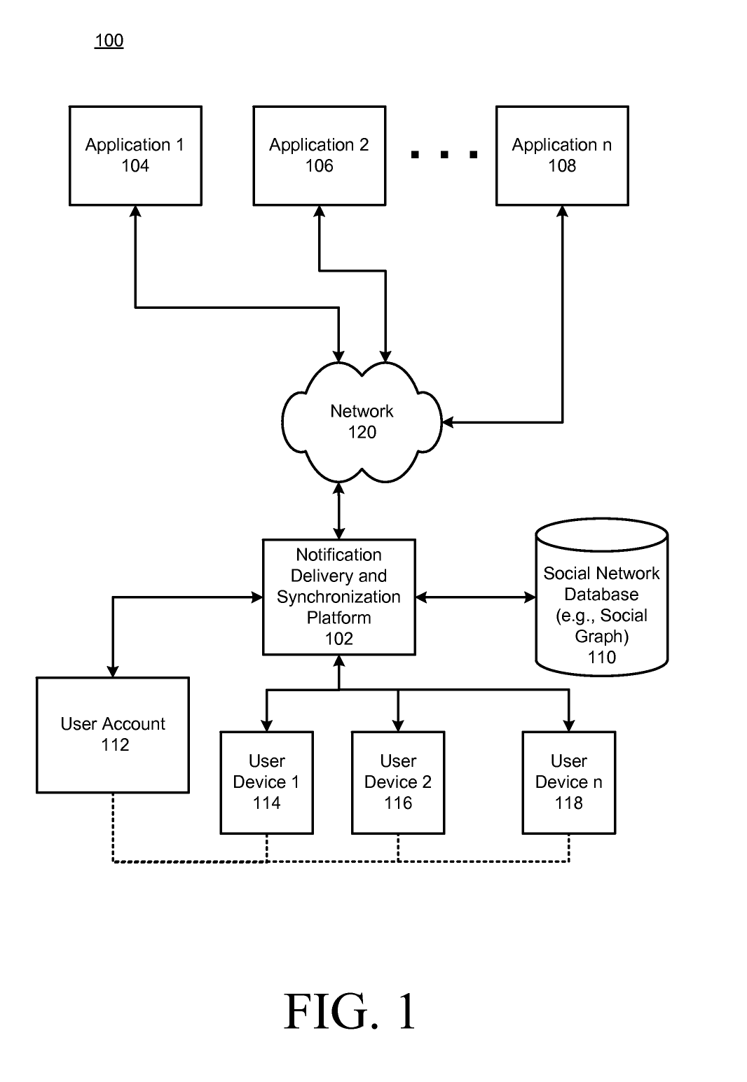

FIG. 1 shows an example notification delivery platform environment 100. The environment 100 includes a notification delivery platform 102, a plurality of applications 104-108, a social network database 110, and a user account 112. The user account 112 is associated with a plurality of user devices 114 -118.

In operation, the notification delivery platform 102 receives notification messages for delivery from one or more of the applications 104-108. Also, the notification delivery platform 102 can receive social graph information from the database 110 and user device usage characteristics from the devices 114-118 associated with the user account 112. The notification delivery platform can receive one or more notifications from the applications 104-108, via network 120, and can prioritize delivery of the notifications based on the social graph information and/or device usage characteristics.

For example, the notification delivery platform 102 can use information from the social graph 110 to determine a social affinity between the notification message recipient and a user associated with one or more of the notification messages. The notification messages coming from users having higher social affinity may be delivered first, or with a higher priority, than notification messages coming from a user having a lower social affinity.

Also, notification messages may be delivered based on one or more device usage characteristics. For example, if two users log into their accounts from the same device it can be inferred that the two users have a high degree of social affinity (or other social connection to each other) such that they are able to log in using the same device (e.g., they may be married). This information can be used to prioritize the delivery of notification messages between the two users.

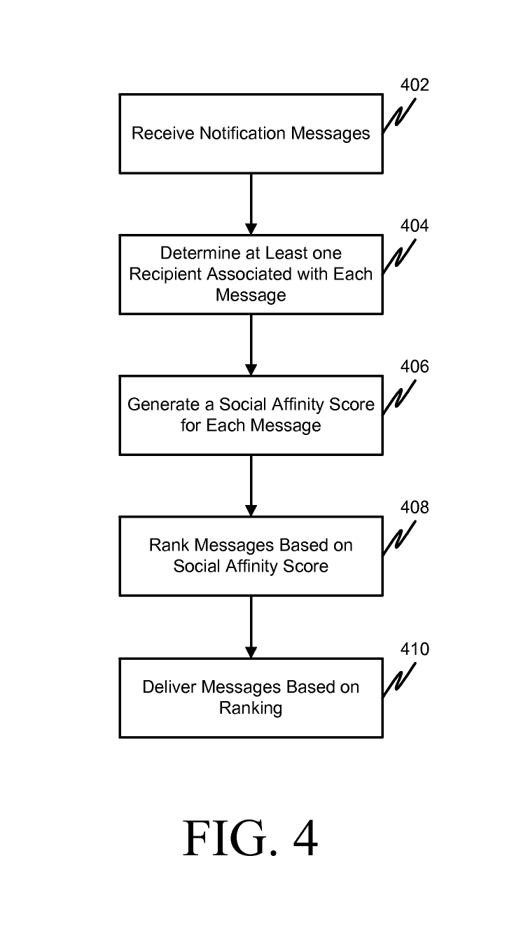

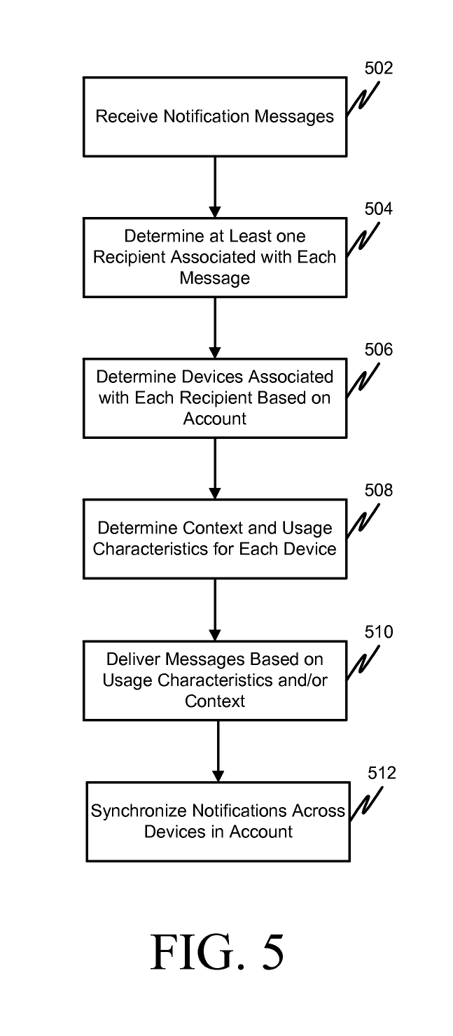

Delivery of notifications based on social affinity and/or device usage characteristics is described in greater detail below in connection with FIGS. 4 and 5.

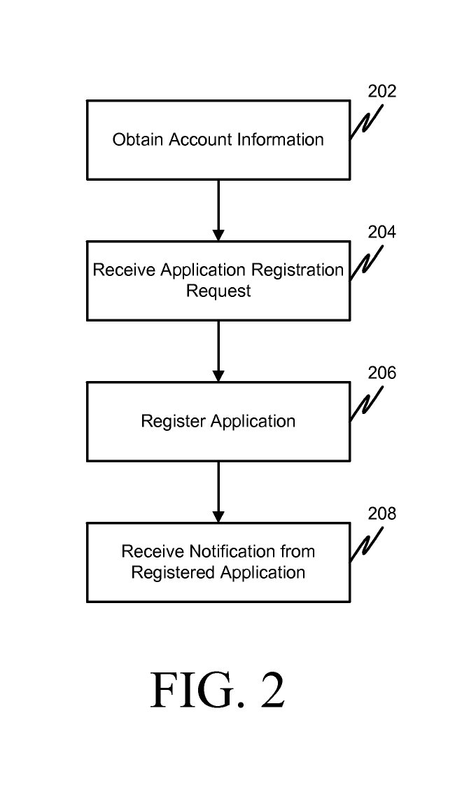

FIG. 2 shows an example method for notification delivery in accordance with some implementations. Processing begins at 202, where user account information is obtained. User account information can include a listing of devices associated with the account and information about the devices, such as capabilities and installed applications. Processing continues to 204.

At 204, an application registration request is received. An installed application or an application server may request to be registered with the notification platform in order to delivery notifications to one or more of the devices associated with the user and/or account. Processing continues to 206.

At 206, the application is registered according to the application registration request. The notification platform may register the application and the notification permissions that have been given by the user. Processing continues to 208.

At 208, a notification is received from the registered application. For example, an external system sends a notification request to the notification platform. The notification can include a unique identifier of the user and/or device, the notification information and metadata or other information associated with the notification (e.g., response options, notification type, URL of web service associated with application, application identifier and the like). Processing continues to 210.

At 210, the notification from the registered application is delivered based on account information and/or social affinity. The account information can include devices associated with the user account, notice states associated with those devices, and the like. The notification can also be delivered based on device usage characteristics and device usage context, or a combination of the above.

It will be appreciated that 202-210 can be repeated in whole or in part in order to accomplish a contemplated notification delivery task.

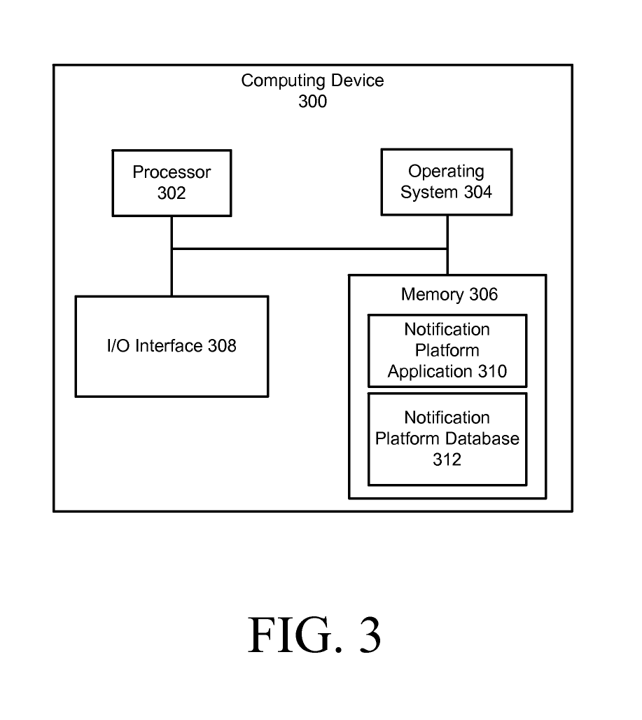

FIG. 3 is a diagram of an example computing device 300 that can be used as a notification platform or user device in accordance with some implementations. The computing device 300 includes a processor 302, operating system 304, memory 306 and I/O interface 308. The memory 306 can include a notification platform (or client) application 310 and a notification database 312.

In operation, the processor 302 may execute the notification platform application 310 stored in the memory 306. The notification platform application 310 can include software instructions that, when executed by the processor, cause the processor to perform operations for a notification platform in accordance with the present disclosure (e.g., the notification platform 310 can perform one or more of steps 202-210 described above and/or one or more of 402-410, 502-512 and/or 1102-1116 described below and, in conjunction, can access the notification database 312). The notification platform 310 can also operate in conjunction with the operating system 304, and a user account system and a social graph of a social network system (as shown in FIG. 1).

The notification platform computing device (e.g., 102 and/or 300) can include, but is not limited to, a single processor system, a multi-processor system (co-located or distributed), a cloud computing system, or a combination of the above.

The client (or user) device(s) can include, but are not limited to, a desktop computer, a laptop computer, a portable computer, a tablet computing device, a smartphone, a feature phone, a personal digital assistant, a media player, televisions, an electronic book reader, an entertainment system of a vehicle or the like. Also, user devices can include wearable computing devices (e.g., glasses, watches and the like), furniture mounted computing devices and/or building mounted computing devices.

The user devices can be connected to a notification platform via a network (e.g., 120). The network connecting user devices to the notification platform can be a wired or wireless network, and can include, but is not limited to, a WiFi network, a local area network, a wide area network, the Internet, or a combination of the above.

The data storage, memory and/or computer readable medium can be a nontransitory medium such as a magnetic storage device (hard disk drive or the like), optical storage device (CD, DVD or the like), or electronic storage device (RAM, ROM, flash, or the like). The software instructions can also be contained in, and provided as, an electronic signal, for example in the form of software as a service (SaaS) delivered from a server (e.g., a distributed system and/or a cloud computing system).

FIG. 4 shows a flow chart of an example method for notification delivery based on social affinity. Processing begins at 402, where one or more notification messages are received. Processing continues to 404.

At 404, at least one recipient associated with each message is determined. Processing continues to 406. At 406, a social affinity score is generated for each message. The social affinity score can be based on the recipient's relationship with other people associated with the message, such as the sender and/or other recipients of the message. For example, a social affinity score can be based on the degree of separation between the message sender and the recipient. The social affinity score can also be based on the recipient's history of social network activity. For example, the score can reflect whether the recipient reads or dismisses messages from the sender.

The social affinity score can also be based on a user's duration on the social network, the number of interactions between a recipient and a sender, a location history of the sender and/or recipient, a duration of check-in of the sender and/or recipient, a frequency of check-in of the sender and/or recipient, a pattern of social network usage, authorship (e.g., whether the notification relates to content the recipient has authored or posted) and/or the like. The social affinity score can be determined based on a weight and value function in which each value is scaled according to a corresponding weight value in order to emphasize or de-emphasize certain values. Processing continues to 408.

At 408 notification messages are ranked based on the social affinity score computed at 406 for each message. For example, the messages can be ranked in order of highest to lowest affinity score. Processing continues to 410.

At 410, the notification messages are delivered based on the ranking For example, the messages associated with a higher social affinity score may be delivered first and displayed with an indication of higher priority, while messages associated with a lower affinity score may be summarized into a digest notification message, may have the delivery delayed or a combination of the above. It will be appreciated that 402-410 can be repeated in whole or in part in order to accomplish a notification delivery task based on social affinity.

FIG. 5 is a flow chart of an example method for notification delivery based on device usage. Processing begins at 502, where one or more notification messages are received. Processing continues to 504.

At 504, a recipient associated with each message is determined. Processing continues to 506.

At 506 devices associated with each recipient are determined. The devices can be determined based on an account associated with each recipient. Processing continues to 508.

At 508, context and usage characteristics of the devices associated with each user (e.g., recipient) are determined. Device usage characteristics can include (but are not limited to) one or more of: the devices a recipient primarily uses to read messages, the devices a recipient primarily uses to respond to messages, what times of a day a recipient uses each device, geo-location of the user when using each device and/or the like. For example, the recipient may primarily use a desktop computer during the work day and primarily use a smart phone in the evenings. The system can then deliver notifications based on these usage characteristics. For example, the system can deliver notifications to the desktop computer at all times and to the smart phone only in the evenings.

In addition to, or as an alternative to device usage characteristics, the system can also determine device usage context and deliver notifications based on device usage characteristics and/or context. For example, context can include geo-location of the user, activity of the user, check-ins of the user, status updates of the user, events the user is attending and the like. For example, the system can determine that the context of a user is that the user is watching a movie. The system can deliver a notification of a friend's review of that movie. Processing continues to 510.

At 510, notification messages are delivered based on usage characteristics. Processing continues to 512.

At 512, notification state across the various devices is synchronized. For example, when a user reads a notification on one device associated with the user's account, the notification can be cleared, removed or indicated as having been read on the other devices associated with that user's account. In another example, if a notification concerns a message such as an email or text message, the notification can be synchronized (e.g., cleared, removed) when the user reads or deletes the message associated with the notification

It will be appreciated that 502-512 can be repeated in whole or in part in order to accomplish contemplated notification delivery task based on device usage characteristics.

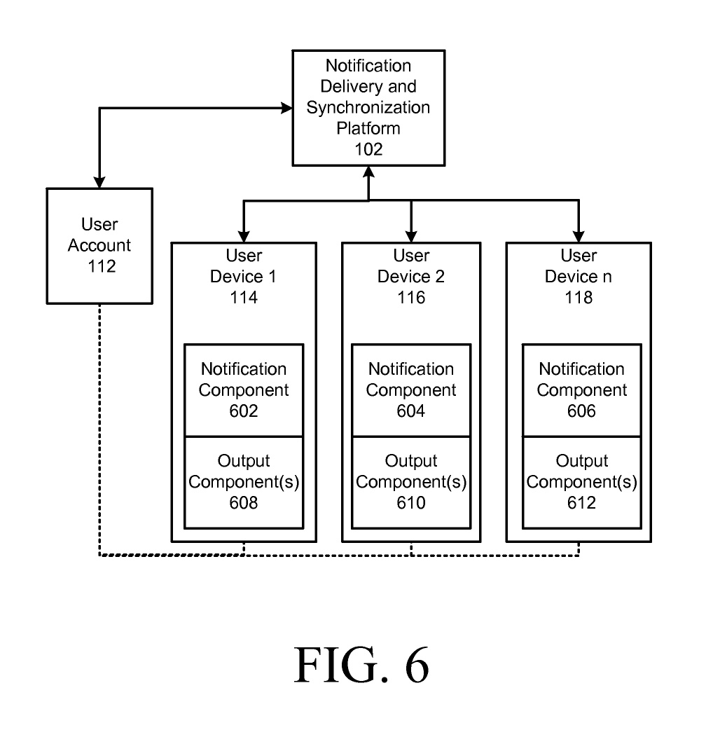

FIG. 6 shows a system for presentation of notifications across multiple devices. The notification delivery platform 102 can receive one or more notification messages and determine a user and user account associated with each message. The platform 102 can determine one or more devices (e.g., 114-118) associated with a user account.

Once the devices associated with a user account (e.g., 114-118) are determined, the platform can obtain device attributes for each device. The attributes can be obtained from the user account or from the devices. The notification messages can be tailored (in format and/or content) for each device based on that device's attributes.

The notification platform 102 can send notifications to a corresponding notification component (602-606) on each respective device. The notification component (602-606) can cause the notification to be displayed on one or more output components (608-612, respectively).

The output components 608-612 can include display screens, head mounted displays, furniture or wall-mounted displays, vehicle-mounted displays, projection displays, audio output devices, tactile output devices, a printer or the like.

The tailoring of notification messages can help provide a seamless experience across device platforms and can help optimize notifications for device platform strengths. Different device platforms may receive different notifications, where the notifications have been tailored to the device platform capabilities, such as display size. For example, a user may have registered an airline application, which is transmitting a notification about a flight delay and gate change. For an email platform, the notification platform may deliver the entire notification (e.g., “Flight 123 has been delayed and is now departing from Gate 23 in Terminal 2”). However, for wearable computing glasses, the notification platform may deliver a notification having reduced information density (e.g., the notification may simply state “Delayed. Terminal 2”).

The optimization of notifications to different devices can also include tailoring based on device input capabilities. A notification can include one or more actionable user interface elements (e.g., screen buttons, audio prompts or the like). For example, a response to a notification received at a desktop or laptop computing platform can be based on keyboard input, a response from a touch screen device can be based on gesture input and a response from a wearable device (e.g., glasses and/or watches) may be based on voice input.

Notification messages can also be formatted based on priority. For example, the message font, font size, color, volume (for audio messages) can be formatted according to a message priority level (e.g., low, medium, high).

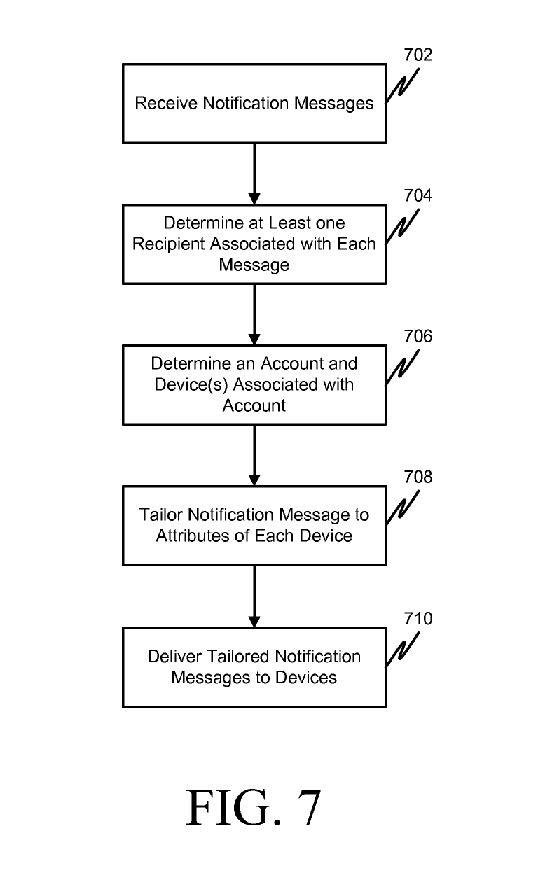

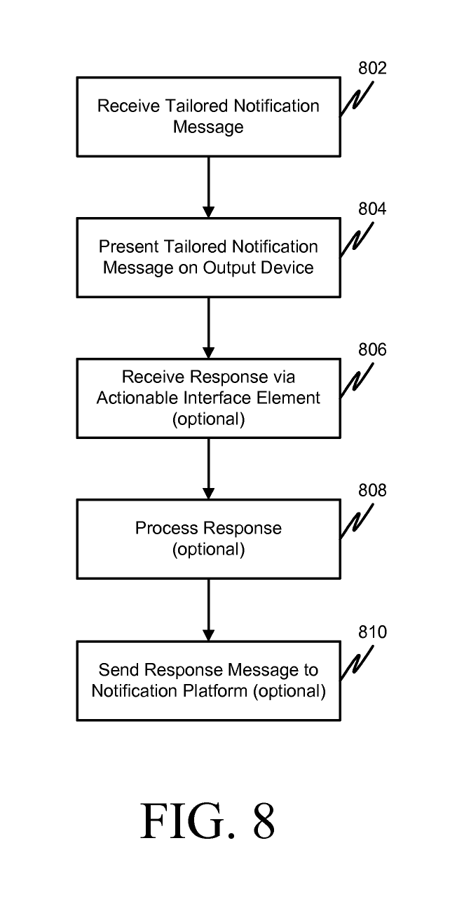

The optimization of the notifications can be performed at the notification platform level and/or at the device platform level. Each device can include the presentation optimization capabilities within the notification component (e.g., 602-606). The notification component (606) can have information about the device output components (608-612, respectively) and device input capabilities. The notification platform can deliver notification message to multiple devices (e.g., heterogeneous or homogenous devices) according to the methods set forth in FIGS. 7 and 8, which are described below.

FIG. 7 is a flow chart of an example method for notification delivery across multiple devices. Processing begins at 702, where one or more notification messages are received by a notification platform (e.g., 102). Processing continues to 704.

At 704, the system can determine at least one recipient associated with each message. Processing continues to 706.

At 706, the system can determine an account associated with each recipient. Based on the account information, the system can determine one or more devices associated with each account. Attributes for each device can be obtained from the account and/or from the devices. The attributes can include, but are not limited to, screen size, screen orientation, screen resolution, screen density, device type and device operating system. Processing continues to 708.

At 708, notification messages are tailored to each device based on the corresponding device attributes. The tailoring can include message format and/or content. Processing continues to 710.

At 710, the tailored notification messages are delivered to each device. The tailoring can be performed at the notification platform and/or at each device. If the tailoring was performed on each device, then at 710 the notification can be caused to be displayed. It will be appreciated that 702-710 can be repeated in whole or in part in order to accomplish a contemplated notification delivery task.

FIG. 8 is a flow chart of an example method for handling tailored notification messages on a device. Processing begins at 802, where one or more tailored notification messages are received (or generated if the tailoring is being performed on the device). Processing continues to 804.

At 804, the tailored notification message(s) are presented on an output component of the device (e.g., screen, audio output component, tactile output component or the like). Processing continues to 806.

At 806, the device optionally receives a response to one or more actionable user interface elements associated with a notification message. Processing continues to 808.

At 808, the response is optionally processed. For example, the system may need to process voice or gesture data to obtain a text value. Processing continues to 810.

At 810, the response is optionally sent to the notification platform (or directly to another application or system). It will be appreciated that 802-810 can be repeated in whole or in part in order to accomplish a contemplated notification delivery task.

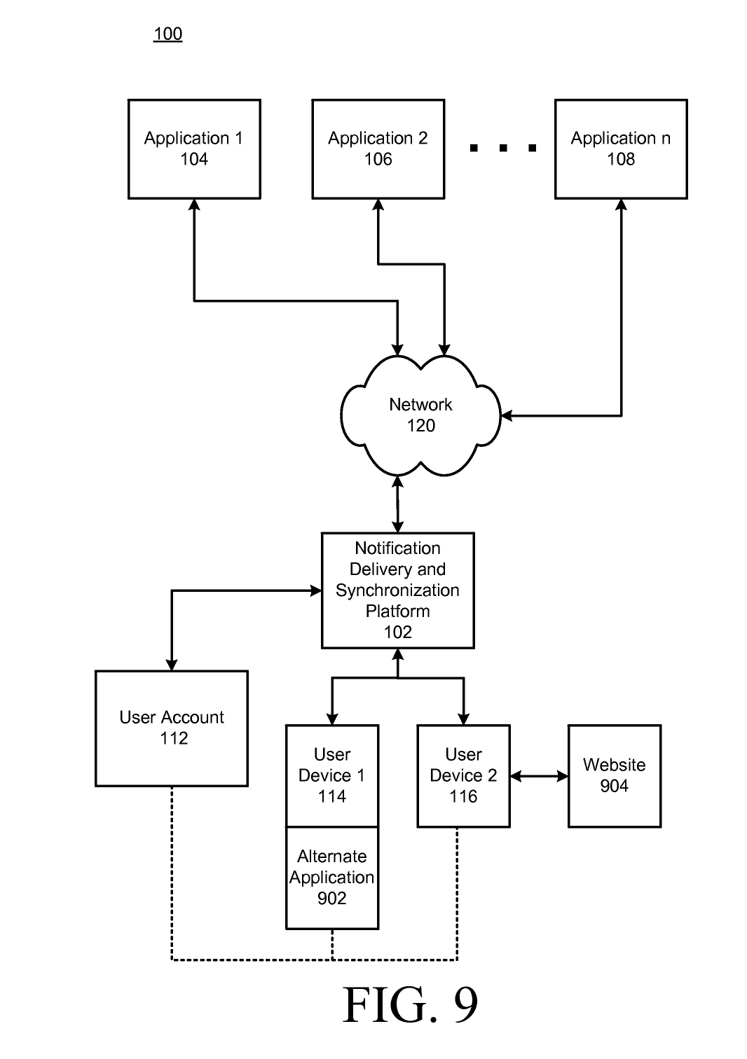

FIG. 9 is a diagram of an example system for notification delivery to devices without appropriate applications installed in accordance with some implementations. In operation, the notification delivery and synchronization platform 102 can determine that one of the user devices is a target device based on the device currently being used by the user or the device that was most recently used by the user.

In a first example, the platform 102 determines that user Device 1 114 is the target device. However, the platform (or a notification component on the device) determines that on Device 1 114 an appropriate application is unavailable. A different notification is sent to an alternate application 902. For example, the different notification may direct the recipient to a different device (e.g., User Device 2 116) that has an appropriate application available.

In another example, the platform 102 determines that user Device 2 116 is the target device. However, the platform (or a notification component on the device) determines that on Device 2 116 an appropriate application is unavailable. So, when the notification is sent to User Device 2, the device uses other information in the notification message (e.g., a website URL) to connect the recipient to an alternate version of the application that sent the notification. For example, the recipient can be connected to a web-based version of the application via the URL included as part of the notification message. Further, actionable user interface elements in the notification message may also be linked to an alternate version (e.g., the web-based version) when an appropriate application is unavailable.

In some implementations, the platform and/or device may not know ahead of time whether an appropriate application is available to handle the notification. Information about accessing applications in alternate ways (e.g., via a web interface) can be provided with the notification from the platform (e.g., encoded in the notification by the application).

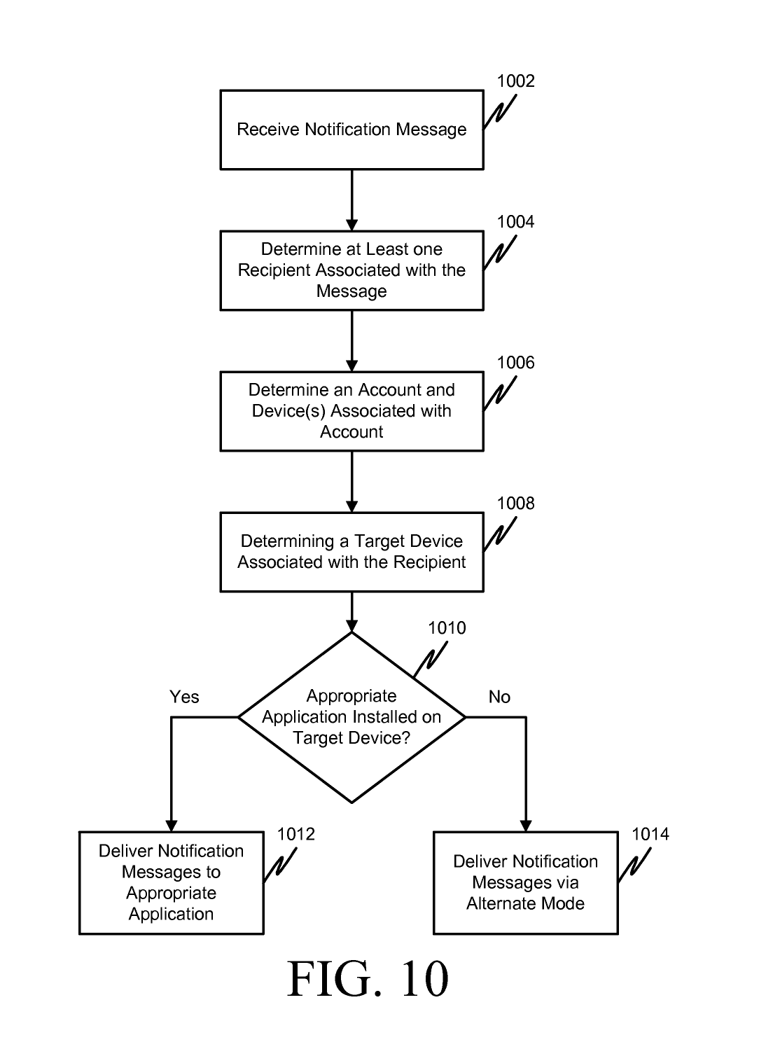

FIG. 10 is a flow chart of an example method for notification delivery to devices without appropriate applications installed in accordance with some implementations. Processing begins at 1002, where a notification message is received. Processing continues to 1004.

At 1004, at least one recipient associated with the message is determined. Processing continues to 1006.

At 1006, an account and devices associated with the account are determined. Processing continues to 1008.

At 1008, a target device associated with the recipient is determined. Processing continues to 1010.

At 1010, it is determined whether there is an appropriate application installed on the target device. If so, processing continues to 1012. If not, processing continues to 1014.

At 1012, the notification message is delivered to the appropriate application for handling.

At 1014, the notification is delivered via an alternate mode, such as delivering a notification to an installed application directing the recipient to another device associated with the recipient, and connecting the recipient to an alternate version of the application sending the notification message.

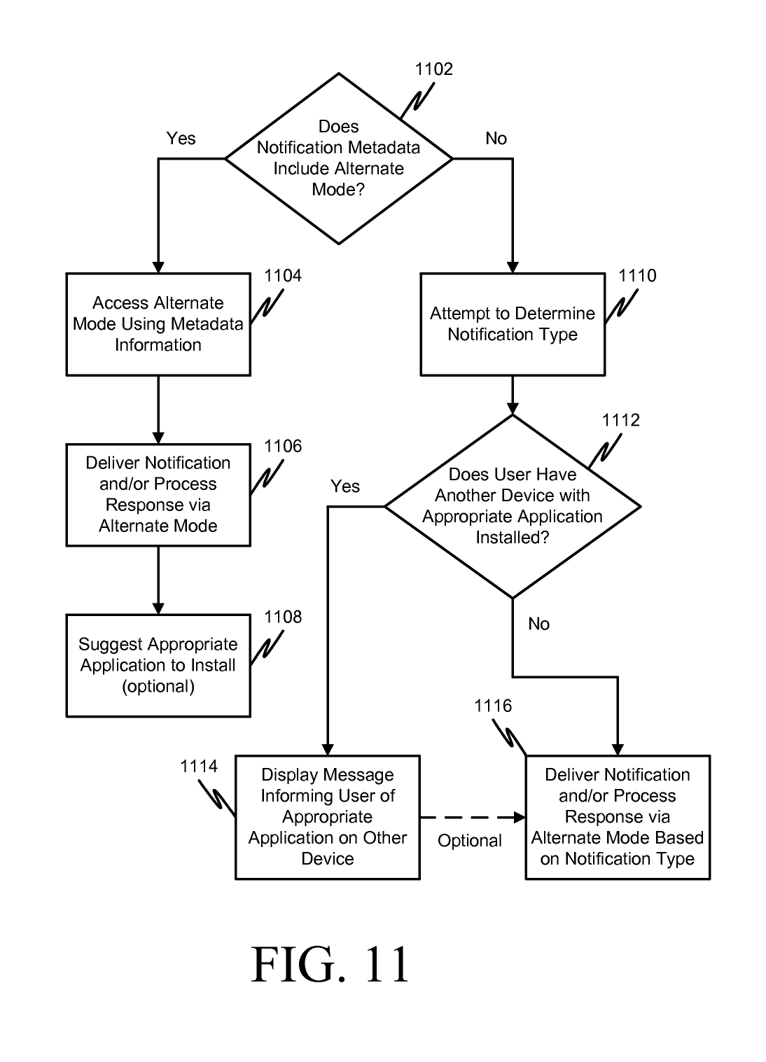

FIG. 11 is a flow chart of an example method for notification delivery via an alternate mode. Processing begins at 1102, where it is determined whether the notification includes metadata indicating an alternate mode for notification delivery and/or response processing. For example, the notification message may include metadata indicating a URL associated with the application sending the notification message, the type of notification (e.g., text, audio, video or the like), or other information indicating an alternate mode for processing the notification or response to the notification. If the notification message contains metadata indicating an alternate mode, processing continues to 1104, otherwise processing continues to 1110.

At 1104, the system accesses the alternate mode using the metadata information. For example, the system could open a browser and access a URL supplied in the metadata of the message. Processing continues to 1106.

At 1106, the system delivers the notification and/or processes the response via the alternate mode. For example, the system could display the notification message via the website associated with the URL accessed in step 1104. Processing continues to 1108.

At 1108, the system can optionally suggest an appropriate application to install if one is available and is able to be identified by the system.

At 1110, the system attempts to determine the notification type and/or type of application that sent the notification. Processing continues to 1112.

At 1112, the system determines whether there is another device associated with the user's account that has an appropriate application installed for handling the notification and/or response. For example, if the notification is from a social networking service, the system can determine if the user has another device associated with his/her account that has an application installed for the social networking service. If so, processing continues to 1114, otherwise processing continues to 1116.

At 1114, the system can cause a message to be displayed that directs the user to the other device associated with the account that has the appropriate application installed. Processing can optionally continue to 1116.

At 1116, the notification can be delivered and/or response processed via an alternate mode based on the type of notification as determined at step 1110.

It will be appreciated that 1102-1116 can be repeated in whole or in part in order to accomplish a contemplated notification delivery task.

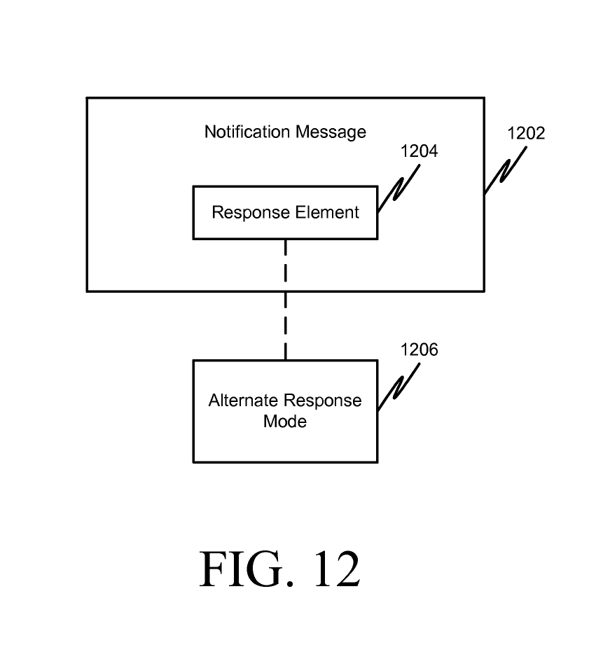

FIG. 12 is a diagram of an example notification response via an alternate mode in accordance with some implementations. A notification message 1202 can include a response element 1204. The response element 1204 can be a button or one or more other user interface element(s) that permits a user to respond to a notification. For example, the response element 1204 can include a button for replying to a message (e.g., a text message, chat message, email message or the like).

When the user device receives an indication that the response element 1204 has been selected (e.g., a reply button has been pressed) the user device can process the response via an appropriate application installed on the user device or via an alternate mode when an appropriate application is not installed. The alternate mode can include using notification information (e.g., metadata) to access an alternate mode for processing the response (e.g., accessing a website via a URL provided in the notification metadata), processing the response via another mode different than the application associated with the notification and the like. The alternate mode can also include delivering the notification to an installed application directing the recipient to another device associated with the recipient, and connecting the recipient to an alternate version of the application sending the notification message.

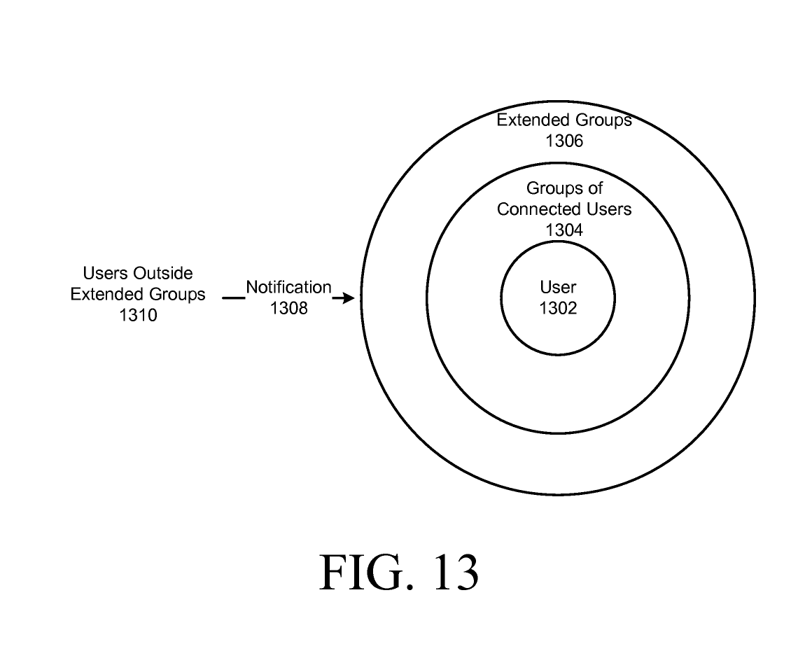

FIG. 13 shows a diagram of an example low priority notification in accordance with some implementations. In particular, a user 1302 can have one or more groups of connected users 1304. The user 1302 can also have one or more extended groups 1306. The extended groups are groups that include one or more users that are also members of the groups of connected users 1304.

In operation, a notification 1308 can be received from a user that is outside of the extended groups 1306 and the groups of connected users 1304. Such a notification can be categorized as a low-priority notification. The system can deliver low-priority notification to the device for display in a section of notifications configured for low-priority notifications. Also, the low-priority notifications may not alert the user upon delivery (e.g., by ringing, buzzing, or visually alerting on a device) and may not be shown in a notification tray (e.g., a section of the device user interface configured to display notifications or icons indicating availability of notifications). Low-priority notifications may be loaded on demand by the device, which can reduce battery power and/or bandwidth usage associated with low priority notifications.

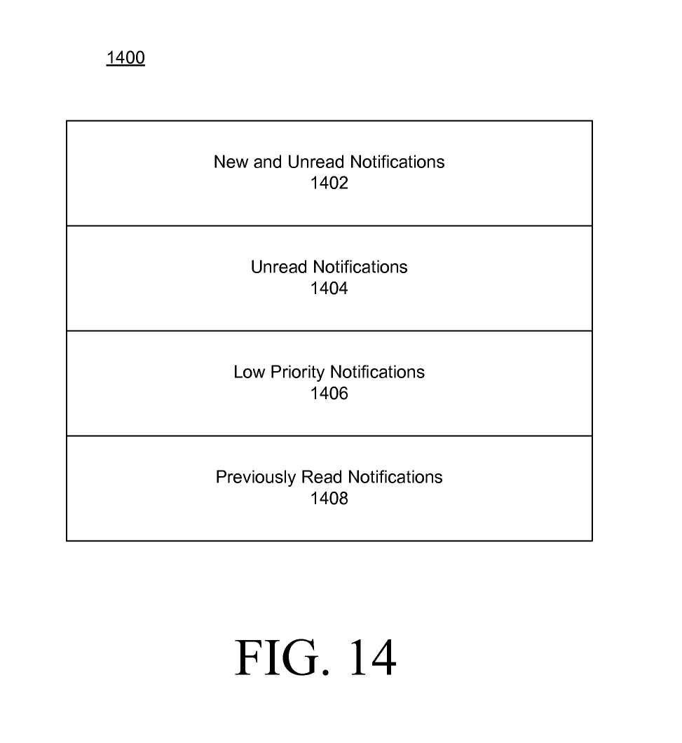

FIG. 14 shows a diagram of an example notification user interface in accordance with some implementations. In particular, a notification tray 1400 can include a new and unread notification section 1402, an unread notification section 1404, a low-priority notification section 1406 and a previously read notification section 1408.

In operation, new, unread incoming notifications can be sent to the new and unread section 1402. This section may be collapsed or may be expanded by default to enable a user to more readily view these notifications. Once a notification has been seen by a user, but not read, it can be moved to the unread notifications section 1404.

Once a notification has been read, that notification can be moved to the previously read notifications section 1408. The previously read notifications 1408 can be sorted and displayed by time-delivered to the previously read section. Previously read low-priority notifications can be accessed in a separate section of the previously read notifications section 1408.

Low-priority notifications, as described above, are held in the low priority notification section 1406, which can be collapsed by default and opened when requested by a user. Once a low-priority notification has been read, it can be moved to the previously read notification section 1408. Unread low-priority notifications can be ranked by social affinity and/or other factor(s).

The new and unread notifications 1402 and the unread notifications 1404 may both be shown as expanded sections in the user interface. The new and unread notifications 1402 may be made more visually prominent (e.g., by having bolder colors and or text, or the like) than the unread notifications 1404, which may be deemphasized by slight “graying out” of text and/or images, or by having more muted colors and/or text as compared to the new and unread notifications 1402.

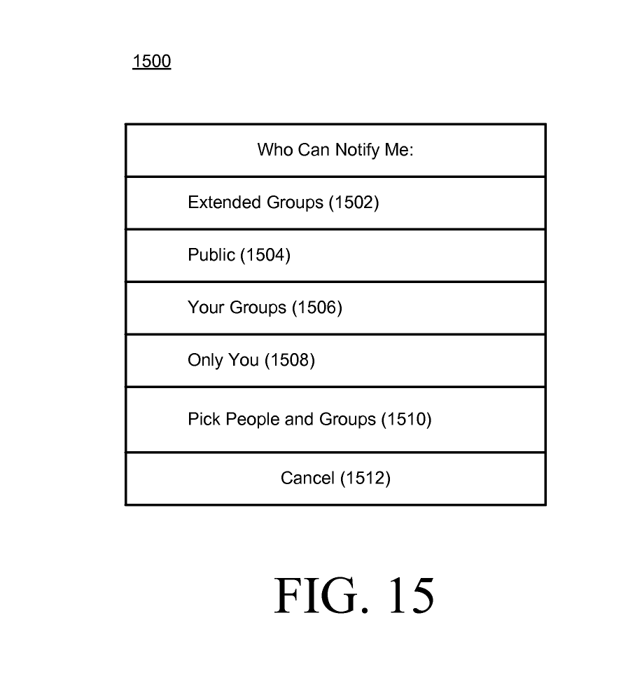

FIG. 15 shows a diagram of an example user interface for setting notification preferences in accordance with some implementations. In particular, a notification setting interface 1500 can be configured to permit a user to select “who can notify me”. In other words, the user can select which users or groups that notifications are permitted to be received from. The notifications settings can also be used to determine which notifications are considered “normal” priority and which are considered low-priority.

In operation, a user can select to receive notifications from one or more of extended groups 1502, the public 1504, other users in the user's groups 1506, and only the user 1508. The user can also select the “Pick People and Groups” selection 1510, which is configured to permit the user to select specific users and/or groups from which to receive notifications. The user interface also includes a cancel element 1512 to close the interface without making changes. Any changes to the notification settings can be automatically saved when the user exits the interface via any method other than the cancel element 1512, or a user interface element for saving the setting changes (not shown) can be provided.

In addition or as an alternative to the method described above for determining a low-priority notification, the device and/or notification platform can also use the notification setting to determine low-priority notifications. For example, the notification platform and/or device can determine that any notification not from one of the users or groups selected in the settings user interface 1500 is a low-priority notification.

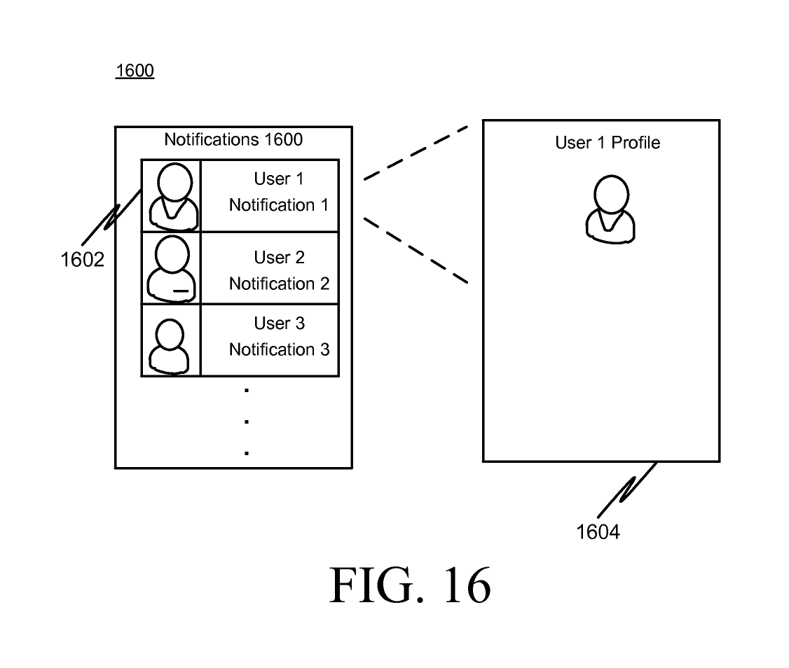

FIG. 16 shows a diagram of an example user interface 1600 for viewing user information from a notification. In operation, when an icon or image of a user associated with a notification 1602 is tapped (or selected), a profile page 1604 associated with that user can be displayed.

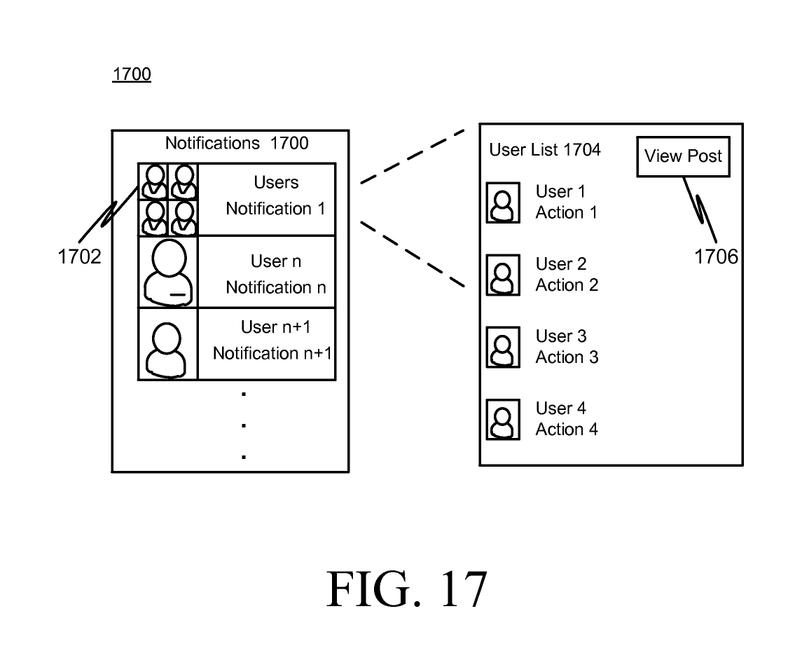

FIG. 17 shows a diagram of an example user interface 1700 for viewing user information for multiple users from a notification. In operation, when an icon or image of multiple users associated with a notification 1702 is tapped (or selected), a list 1704 showing the users and, optionally, an action taken by each user associated with the notification can be displayed. Also, the user list interface 1704 can include a button, link or other element 1706 to view the post that the users in the list took an action on (e.g., recommended, commented on, reposted or the like).

Some implementations of the disclosed method, system, and computer readable media can be implemented in software (e.g., as a computer program product and/or nontransitory computer readable media having stored instructions for notification delivery to devices without appropriate applications installed as described herein). The stored software instructions can be executed on a programmed general purpose computer, a special purpose computer, a microprocessor, or the like.

It is, therefore, apparent that there is provided, in accordance with the various example implementations disclosed herein, systems, methods and computer readable media for notification delivery to devices without appropriate applications installed.

While the disclosed subject matter has been described in conjunction with a number of implementations, it is evident that many alternatives, modifications and variations would be or are apparent to those of ordinary skill in the applicable arts. Accordingly, Applicants intend to embrace all such alternatives, modifications, equivalents and variations that are within the spirit and scope of the disclosed subject matter.

1. A method comprising:
receiving a notification message having a recipient associated with the notification message;
accessing account information associated with the recipient including a list of one or more devices associated with the recipient;
identifying a target device from the list of one or more devices associated with the recipient;
determining, at a notification platform, one or more of a notification message type of the notification message and a type of application that sent the notification message;
determining, at the notification platform, whether the target device has an appropriate application installed to process the notification message based on one of the notification message type and the type of application that sent the notification message;
delivering the notification message from the notification platform to the target device based on the determining whether the target device has an appropriate application installed to process the notification message performed at the notification platform, wherein the delivering includes:
when the target device has an appropriate application installed, delivering the notification message to the appropriate application; and
when the target device does not have an appropriate application installed, delivering the notification message via an alternate delivery mode, wherein the alternate delivery mode includes delivering a notification to an installed application directing the recipient to another device associated with the recipient.

2. A method comprising:
receiving a notification message;
identifying a target device associated with a recipient of the notification message;
determining, at a notification platform, one or more of a notification message type of the notification message and a type of application that sent the notification message;
determining, at the notification platform, whether the target device has an appropriate application installed to process the notification message based on one of the notification message type and the type of application that sent the notification message;
delivering the notification message from the notification platform to the target device based on the determining whether the target device has an appropriate application installed to process the notification message performed at the notification platform, wherein the delivering includes:
when the target device has an appropriate application installed, delivering the notification message to the appropriate application; and
when the target device does not have an appropriate application installed, delivering the notification message via an alternate delivery mode, wherein the alternate delivery mode includes delivering a notification to an installed application directing the recipient to another device associated with the recipient.

3. (canceled)

4. The method of claim 2, wherein the other device has an appropriate application installed.

5. The method of claim 2, wherein the target device is a device that the recipient is actively using.

6. The method of claim 2, wherein the target device is a device that was most recently used by the recipient.

7. The method of claim 2, wherein the alternate delivery mode includes presenting one or more actionable user interface elements with the notification message, wherein the one or more actionable user interface elements have been modified based on capabilities of the target device.

8. The method of claim 2, further comprising delivering low-priority notifications to a low priority section of a user interface regardless of whether an appropriate application is installed for handling the low-priority notification.

9. The method of claim 2, wherein the alternate delivery mode includes connecting the recipient to an alternate version of an application sending the notification message, and wherein the alternate version is a web-based version of the appropriate application viewable in a web browser on the target device.

10. A system comprising:
one or more processors configured to perform operations including:
receiving a notification message;
identifying a target device associated with a recipient of the notification message;
determining, at a notification platform, one or more of a notification message type of the notification message and a type of application that sent the notification message;
determining, at the notification platform, whether the target device has an appropriate application installed to process the notification message based on one of the notification message type and the type of application that sent the notification message;
delivering the notification message from the notification platform to the target device based on the determining whether the target device has an appropriate application installed to process the notification message performed at the notification platform, wherein the delivering includes:
when the target device has an appropriate application installed, delivering the notification message to the appropriate application; and
when the target device does not have an appropriate application installed, delivering the notification message via an alternate delivery mode, wherein the alternate delivery mode includes delivering a notification to an installed application directing the recipient to another device associated with the recipient.

11. (canceled)

12. The system of claim 10, wherein the other device has an appropriate application installed.

13. The system of claim 10, wherein the target device is a device that the recipient is actively using.

14. The system of claim 10, wherein the target device is a device that was most recently used by the recipient.

15. The system of claim 10, wherein the alternate delivery mode includes presenting one or more actionable user interface elements with the notification message, wherein the one or more actionable user interface elements have been modified based on capabilities of the target device.

16. The system of claim 15, wherein the one or more actionable user interface elements are modified based on target device input capabilities.

17. The system of claim 10, wherein the alternate delivery mode includes connecting the recipient to an alternate version of an application sending the notification message, and wherein the alternate version is a web-based version of the appropriate application viewable in a web browser on the target device.

18. A method comprising:
receiving a notification message having a recipient associated with the notification message;
accessing account information associated with the recipient including a list of one or more devices associated with the recipient;
identifying a target device associated with the recipient;
determining, at a notification platform, one or more of a notification message type of the notification message and a type of application that sent the notification message;
determining, at the notification platform, that the target device does not have an appropriate application installed to process the notification message based on one of the notification message type and the type of application that sent the notification message; and
delivering the notification message from the notification platform to the target device based on the determining whether the target device has an appropriate application installed to process the notification message performed at the notification platform, wherein the delivering includes:
delivering the notification message via an alternate delivery mode, wherein the alternate delivery mode includes delivering a notification to an installed application directing the recipient to another device associated with the recipient.

19. (canceled)

20. The method of claim 18, wherein the alternate delivery mode includes connecting the recipient to an alternate version of an application sending the notification message, and wherein the alternate version is a web-based version of the appropriate application viewable in a web browser on the target device.
